(19) United States
(12) Patent Application Publication
(10) Pub. No.: US 2024/0419739 A1
(43) Pub. Date: Dec. 19, 2024

(54) DYNAMIC OFFSET WELL ANALYSIS

(71) Applicant: Schlumberger Technology Corporation, Sugar Land, TX (US)

(72) Inventors: Crispin Chatar, Katy, TX (US); Prasham Sheth, Sunnyvale, CA (US)

(21) Appl. No.: 18/745,663

(22) Filed: Jun. 17, 2024

Related U.S. Application Data
(60) Provisional application No. 63/508,619, filed on Jun. 16, 2023.

(51) Int. Cl. G06F 16/906; E21B 44/00; G06F 16/901; G06F 16/909

(52) U.S. Cl. CPC G06F 16/906; E21B 44/00; G06F 16/9024; G06F 16/909; E21B 2200/20

(57) ABSTRACT

Dynamic offset well analysis includes receiving a selection of a set of parameters on a well plan comparison tool displayed in a graphical user interface (GUI). For each parameter that is selected, a selection of a set of weights is received from the well plan comparison tool. Dynamic offset well analysis also includes weighting parameter values for objects according to the set of weights. Dynamic offset well analysis additionally includes analyzing the objects according to the weighted parameter values to form clusters. The clusters are then displayed on the well plan comparison tool in the GUI.

This application claims priority to U.S. Provisional Patent Application No. 63/508,619, filed Jun. 16, 2023, the entirety of which is hereby incorporated by reference.

### BACKGROUND

In the oil and gas industry, an offset well is a well that is comparable to an existing well in an oil or gas field. Historically, offset wells have been in close geographical proximity to the existing well.

Offset wells are drilled when the original well is no longer producing at an optimal rate, or when additional oil or gas reserves are discovered in the same field. By drilling a new well in close proximity to an existing one, operators can access additional hydrocarbons and extend the lifespan of the field. Thus, offset wells are used for multiple purposes, such as evaluating the reservoir for potential production, monitoring the performance of existing wells, and/or extracting additional hydrocarbons from the same reservoir. For example, operators may drill an offset well to collect data on the pressure, temperature, and fluid properties of the reservoir, which can be used to improve the performance of existing wells and optimize production.

Offset well information obtained from already-drilled neighbor wells provides data that can be analyzed in order to decrease the uncertainty for a new well. Any hazards or risks experienced while drilling the offset well may be used to guide the planning and development of the new well.

Comparing offsets wells to a target well may involve complicated analyses performed in a high dimensional space. A high dimensional space means that multiple types of data are compared for each of ten or more wells. A technical challenge exists in presenting an analysis performed in a high dimensional space in single screen of a graphical user interface such that a human may readily understand the comparison, but without sacrificing the detail of the high dimensional space analysis.

### SUMMARY

The one or more embodiments provide for a method. The method includes receiving a selection of a set of parameters on a well plan comparison tool displayed in a graphical user interface (GUI). For each parameter that is selected, a selection of a set of weights is received from the well plan comparison tool. The method also includes weighting parameter values for a plurality of objects according to the set of weights. The method additionally includes analyzing the plurality of objects according to the weighted parameter values to form a plurality of clusters. The plurality of clusters is then displayed on the well plan comparison tool in the GUI.

The one or more embodiments also provide for a system. The system includes a processor and a data repository in communication with the processor and storing objects having plurality of parameter values. The system also includes a comparison process executable by the processor to receive a selection of a set of parameters from a well plan comparison tool displayed. For each parameter that is selected, the comparison process receives a selection of a set of weights from the well plan comparison tool. The comparison process weights parameter values for a plurality of objects according to the set of weights. The comparison process clusters the plurality of objects according to the weighted parameter values to form a plurality of clusters. The plurality of clusters can then be displayed on the well plan comparison tool in the GUI.

The one or more embodiments also provide for a graphical user interface (GUI) of a computing system. The graphical user interface includes a display of visualizations on a well plan comparison tool displayed on the GUI. The visualizations are formed by a processor executing a computer-implemented method. The computer-implemented method includes receiving a selection of a set of parameters on a well plan comparison tool displayed in a graphical user interface (GUI). For each parameter that was selected, a selection of a set of weights is received from the well plan comparison tool. The method also includes weighting parameter values for a plurality of objects according to the set of weights. The method additionally includes analyzing the plurality of objects according to the weighted parameter values to form a plurality of clusters. The plurality of clusters is then displayed on the well plan comparison tool in the GUI.

Other aspects will be apparent from the following description and the appended claims.

### BRIEF DESCRIPTION OF DRAWINGS

FIG. 1 shows a computing system in accordance with one or more embodiments.

FIG. 2 is a flowchart of a computer implemented process in accordance with one or more embodiments.

FIG. 3 is a flowchart of a computer implemented process in accordance with one or more embodiments.

FIG. 4 is a flowchart of a computer implemented method in accordance with one or more embodiments.

FIG. 5 shows a graphical user interface (GUI) in accordance with one or more embodiments.

FIG. 6 shows an example data visualization that is displayed in a GUI in accordance with one or more embodiments.

FIG. 7 shows an example data visualization that is displayed in a GUI in accordance with one or more embodiments.

FIG. 8 shows an example data visualization that is displayed in a GUI in accordance with one or more embodiments.

FIGS. 9A and 9B show an example computing system and network in accordance with one or more embodiments.

FIG. 10 shows a top view of a group of wells showing offset wells in a radius around a subject well, in accordance with one or more embodiments.

FIG. 11 shows an example of showing well similarity plot in a two-dimensional map, in accordance with one or more embodiments.

FIG. 12 shows an inverted file index clustering technique portrayed using a Voronoi diagram, in accordance with one or more embodiments.

FIG. 13 is a flowchart representing a workflow for dynamic data-driven offset well analysis, in accordance with one or more embodiments.

FIGS. 14A-C show an alternative graphical user interfaces for displaying and manipulating offset well data, in accordance with one or more embodiments, in accordance with one or more embodiments.

FIG. 15 is a user interface depicting the interface of interacting with the clusters extracted according to the inverted file index technique, in accordance with one or more embodiments.

FIG. 16 is a user interface depicting the interface of interacting with the points inside highlighted clusters in the form of a radar plot, in accordance with one or more embodiments.

FIG. 17 is a user interface depicting the interface of interacting with the points inside highlighted clusters in the form of a two-dimensional plot, in accordance with one or more embodiments.

Like elements in the various figures are denoted by like reference numerals for consistency.

### DETAILED DESCRIPTION

In general, the one or more embodiments relate to graphical representation of complex information on a graphical user interface (GUI) generated by a computing system. In particular, the one or more embodiments are directed to a data-driven method creating well plans for offset wells, including, in part, by expanding the definition of offset wells to include wells of similar attribute types, regardless of geographical relationships. By leveraging data-driven approaches, drilling engineers can make informed decisions, optimize drilling parameters, and enhance the success and efficiency of offset well operations. The illustrative embodiments leverage machine learning algorithms to analyze global data sets, reducing the time used for data analysis and allowing drilling engineers to focus on decision-making tasks. This allows for a more comprehensive understanding of reservoir characteristics, production trends, and drilling parameters.

Thus, the illustrative embodiments address the technical challenge of displaying a large amount of information on a GUI in a manner useful to a human user. The GUI presents high-dimensional data in a lower-dimensional space leveraging one or more machine learning algorithms to reduce the dimensionality of the data while maintaining the relationships and patterns present in the high-dimensional space. The GUI of the illustrative embodiments enables an easier visualization of nonlinear structures and complex relationships in the data. Thus, the GUI can reveal intricate patterns that may not be easily apparent in higher dimensions, making the GUI well-suited for exploring and understanding complex datasets.

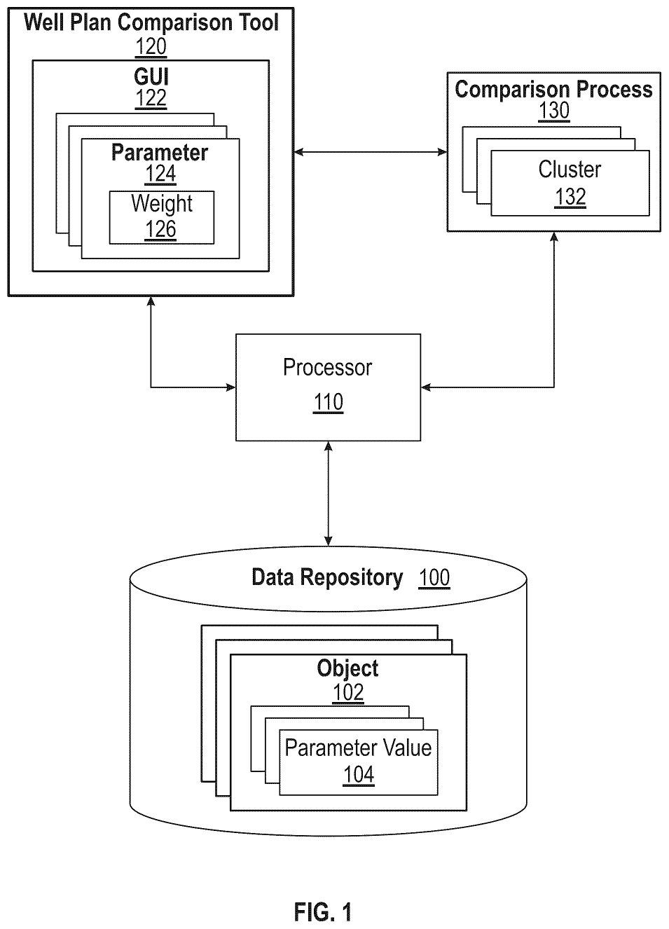

Attention is now turned to the figures. FIG. 1 shows a computing system, in accordance with one or more embodiments. The computing system shown in FIG. 1 includes a data repository (100), a processor (110), a well plan comparison tool (120), and comparison process (130),

In some embodiments, the data repository (100) is a storage unit and/or device (e.g., a file system, database, collection of tables, or any other storage mechanism) for storing data. Further, the data repository (100) may include multiple different storage units and/or devices. The multiple different storage units and/or devices may or may not be of the same type and may or may not be located at the same physical site.

The data repository (100) stores an object (102) among multiple objects. The object (102) is a computer-readable data structure that stores information about an entity. The entity may be a real object, a planned object, a social construct (e.g., a well head, a person, a voting location, an automobile, city, etc.), or a virtual object (e.g., an avatar, virtual building, etc.).

In an example, the object (102) can be a well plan or more parameter values (104) among multiple parameter values. The parameter value (104) is the value of a parameter of the object (102). The parameter is an attribute of the object (102). For example, when the object (102) is a well plan, the parameters may include attributes such as drilling parameters, wellbore data, rock parameters, bit specification, and/or equipment specifications.

The drilling parameters represent a set of physical measurements associated with the drilling operation and characterize one or more drilling instrument performance or one or more wellbore properties. For example, the drilling parameters may include rate of penetration (ROP), surface weight on the bit (WOB), downhole weight on the bit (DWOB), surface torque (TOR), downhole torque (DTOR) rotary table rotation per minute (RPM), motor differential pressure, standpipe pressure (SPPA), drilling mud properties, motor differential pressure, mud circulation time and bottom hole temperature (BHT).

The wellbore data represent a set of records of properties along the length of the wellbore and includes information describing the wellbore. For example, the wellbore data may include a description of the trajectory of the wellbore, a description of the location of the wellbore in the oilfield or on Earth.

The rock parameters describe the physical attributes of the rocks of the subsurface formation. For example, the rock parameters may include density, porosity, permeability, lithology, sand content, etc.

The bit specifications refer to the dimensional and material characteristics of the drilling bit that determine the drilling bit performance. The equipment specifications refer to the dimensional and operational characteristics of the drilling equipment that limit one or more of the drilling parameters.

The system shown in FIG. 1 also includes a processor (110) in communication with the data repository (100). The processor (110) is one or more hardware and/or virtual processors, in a distributed computing environment. The processor (110) executes software applications, such as the well plan comparison tool (120) and the comparison process (130) described below.

The system shown in FIG. 1 also includes a well plan comparison tool (120). The well plan comparison tool (120) is a software application that is executable by the processor (110) to generate or modify a graphical user interface; i.e., GUI (122). The GUI (122) is displayed on a display device also in communication with the processor (110). A user may interact with the well plan comparison tool (120) through one or more graphical objects and/or GUI widgets displayed on the GUI (122). A GUI widget is software graphical element displayed on a GUI that is configured to receive user input and/or display output in order to manipulate the software. Examples of widgets include, but are not limited to, a drop-down menu, a scrollbar, a pop-up window, a button, a wheel, etc.

The GUI includes one or more weight (126). Each weight (126) is a scaling factor, presented as a GUI widget, that allows the user to valuate parameters (124) when comparing object(s) (102), for example using cluster process (130).

The system shown in FIG. 1 also includes a comparison process (130). The comparison process (130) is a software application that is executable by the processor (110) to cluster the one or more object (102) into a cluster (132) or into multiple clusters according to the weight (126) assigned to one or more parameter (124) selected for comparison.

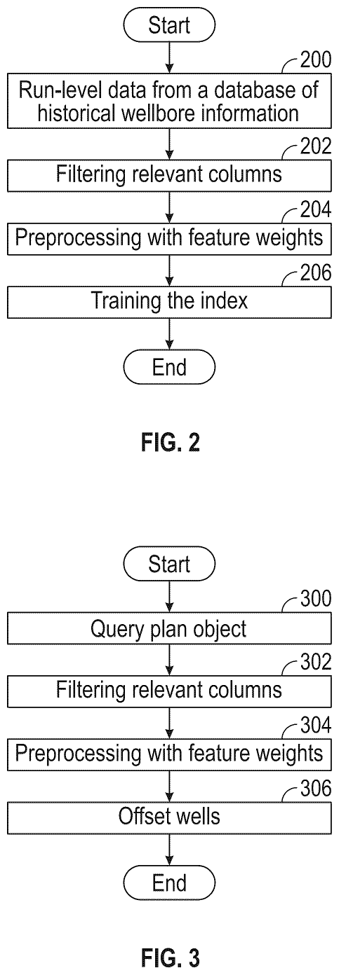

The cluster (132) is a grouping of at least two of the multiple objects. The cluster (132) is generated using the comparison process (130), as described with respect to FIG. 2 through FIG. 4.

For example, a weighted Euclidean distance can be used to consider the weights assigned to each parameter, allowing for a more customized and flexible distance calculation. By assigning different weights to each dimension, a user can control the impact of each parameter on the overall distance calculation. Larger weights amplify the influence of the corresponding parameter, while smaller weights reduce their influence.

A weighted Euclidean distance can be calculated as follows:

$$D = \sqrt{\sum {{w}_{i} ( {x}_{i} - {y}_{i} )}^{2}} \qquad Eq . 1$$

### Wherein:

D is the weighted Euclidean distance between two data points,
wᵢ represents the weight assigned to the i^{th} parameter,
xᵢ and yᵢ are the values of the i^{th} parameter for the objects being compared.

In Equation 1, each difference between the values of corresponding dimensions is squared and then multiplied by the weight assigned to that dimension. The weighted differences are summed across all dimensions, and the square root of the total sum is taken to obtain the final distance. The weights assigned to each dimension can be normalized to ensure a fair comparison and preventing one parameter with a large weight from dominating the distance calculation.

Applying weight (126) in the Euclidean distance calculation allows a user to emphasize certain parameters that should be emphasized in the comparison process (130). For example, if you are comparing well plans based on parameters such as depth, trajectory, and cost, a user can assign higher weights to parameters that should be emphasized in the comparison process. The weight (126) ensures that the distance calculation reflects the desired priorities, focusing the comparison process (130) according to the parameter (124).

While FIG. 1 shows a configuration of components, other configurations may be used without departing from the scope of the one or more embodiments. For example, various components may be combined to create a single component. As another example, the functionality performed by a single component may be performed by two or more components.

FIG. 2 is a flowchart of a computer implemented process for comparison well plan objects based on run level data. However, the method of FIG. 2 may be expanded to include other focus levels of data. The flowcharts shown in FIG. 2 may be implemented as computer readable program code to generate the cluster (132) of FIG. 1. Although the method of FIG. 2 is performed in the context of run-level data, use of run-level data is but one example of the types of data that may be used with respect to the method of FIG. 2. For example, the method of FIG. 2 also may be expanded to use focus on data at different granularities.

At block 200, run level data is received from a database containing historical wellbore information. Historical wellbore information may include, for example, drilling data and wellbore properties data. Run level data may include information about different objects or operations conducted in wells, such as drilling, logging, and testing. For example, the run level data can be object (102). The data may include various attributes or parameters related to these runs. For example, the data may contain information about various runs performed in offset wells, such as drilling parameters, geological characteristics, wellbore trajectories, and other relevant data.

At block 202, columns are filtered from the run level data. The columns can be filtered. based on the selected parameters received from GUI (122). The columns could represent parameters like drilling depth, mud weight, penetration rate, formation properties, etc. Once the run level data is obtained, relevant columns or attributes are selected or filtered. The involves identifying and extracting the specific columns that are to be considered. for the well plan comparison or comparison process, based on the selected parameters received from GUI (122).

At block 204, the run level data preprocessed according to parameter weights. The parameter weights correspond to the set of weights applied to the selected parameters received from GUI (122). The weights can be determined based on expert knowledge, statistical analysis, or optimization techniques. Each parameter weight represents the relative importance or significance of a specific parameter in the comparison process. Each parameter is assigned a weight, giving more emphasis to certain parameters based on their relative importance.

At block 206, the weighted run level data is used to train an index or representation of the data. The index can be derived using machine learning algorithms, such as Approximate Nearest Neighborhood based methods. dimensionality reduction or embedding algorithms, to transform the high-dimensional data into a lower-dimensional space. The index provides a structured representation of the data that captures the inherent relationships and patterns among the objects based on the selected parameters and their weights.

After training the index, it is considered a trained index. This means that the index has been optimized and adjusted based on the selected parameters and the weights assigned to the parameters. The trained index encapsulates the knowledge and patterns extracted from the data. The trained index provides a transformed representation of the data that emphasizes the parameters and their relationships.

From the trained index, dimensionality reduction or embedding algorithms, are utilized to transform the high-dimensional data into a lower-dimensional space. Dimensionality reduction helps to create a visualization that increases the explainability of the algorithm, i.e., what is happening inside the index, using a lower-dimensional similarity measure. The similarity measures can be based on various algorithms or distance metrics, such as Euclidean distance, cosine similarity, or comparison techniques. Offset wells with the highest similarity scores or closest proximity in the parameter space can be considered as the most similar, and clustered together.

FIG. 3 is a flowchart of a computer implemented process for identifying similar offset wells. The flowcharts shown in FIG. 3 may be implemented as computer readable program code to generate the cluster (132) of FIG. 1.

At block 300, a query plan object is received. The query plan object represents a specific query or request for well plan data. The query may contain details about the desired wellbore trajectory, target depth, geological considerations, and other relevant parameters. The query may include weights for one or more of the specified parameters.

At block 302, relevant columns in the wellbore database based on the query object: The identified columns contain information matching the parameters specified in the query object.

At block 304, identified columns are preprocessed with parameter weights: The parameter weights reflect the relative importance of each parameter in the comparison process. Each parameter or column is assigned a weight that signifies its significance in determining similarity between well plans. This preprocessing ensures that the relevant columns are appropriately weighted based on their importance in the analysis.

At block 306, a trained index (see block 206 of FIG. 2) is used to identify similar offset wells. The trained index contains representations of various wells or well plans. By comparing the representation of the query plan object with the representations of offset wells in the index, similarity measures can be computed. The similarity measures can be based on various algorithms or distance metrics, such as Euclidean distance, cosine similarity, or comparison techniques. Offset wells with the highest similarity scores or closest proximity in the parameter space can be considered as the most similar to the query plan object. These measures help in identifying offset wells that share similar characteristics or attributes with the query plan object.

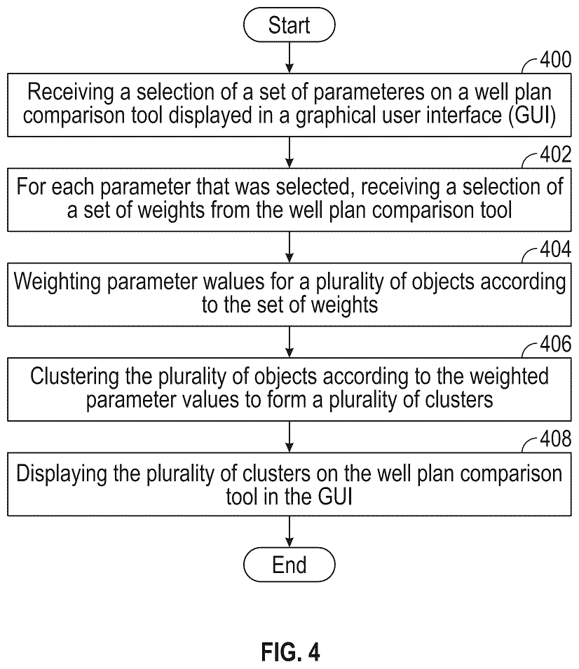

Referring now to FIG. 4, a computer implemented method is shown according to one or more illustrative embodiments. The method of FIG. 4 can be implemented in one or more components of a computer, such as well plan comparison tool (120) and comparison process (130) of FIG. 1. The method enables users to visually analyze and compare different well plans or aspects based on selected parameters and the formed clusters. By providing a systematic and organized representation of the data, the method can aid in decision-making processes related to well planning and optimization.

At block 400, a selection of a set of parameters is received on a well plan comparison tool displayed in a graphical user interface (GUI). For example, a user can select the parameters using one or more graphical objects and/or GUI widgets.

At block 402, a selection of a set of weights is received from the well plan comparison tool for each parameter that was selected. Once the parameters are selected, the user further selects a set of weights for each parameter. The user can select the weights using one or more graphical objects and/or GUI widgets.

At block 404, parameter values are weighted for a plurality of objects according to the set of weights. The parameter values can be values for objects representing different well plans or different aspects of a single well plan. Each object would have corresponding values for the selected parameters, and these corresponding values are scaled by their respective weights to reflect their importance or influence.

At block 406, the plurality of objects is clustered according to the weighted parameter values to form a plurality of clusters. The objects, now with weighted parameter values, are grouped into clusters based on their similarity or proximity in the parameter space. Comparison algorithms are employed to identify objects that share similar characteristics or have similar values for the selected parameters. The similarity measures can be based on various algorithms or distance metrics, such as Euclidean distance, cosine similarity, or other comparison techniques. For example, the comparison can be performed using a weighted Euclidean distance according to Equation 1.

At block 408, the plurality of clusters is displayed on the well plan comparison tool in the GUI. This display provides a visual representation of the clusters, allowing the user to observe and analyze the similarities and differences between different groups of well plans or aspects.

While the various steps in the flowcharts of FIG. 2 through FIG. 4 are presented and described sequentially, one of ordinary skill will appreciate that some or all of the steps may be executed in different orders, may be combined, or omitted, and some or all of the steps may be executed in parallel. Furthermore, the steps may be performed actively or passively. Thus, the one or more embodiments are not necessarily limited by the examples provided herein.

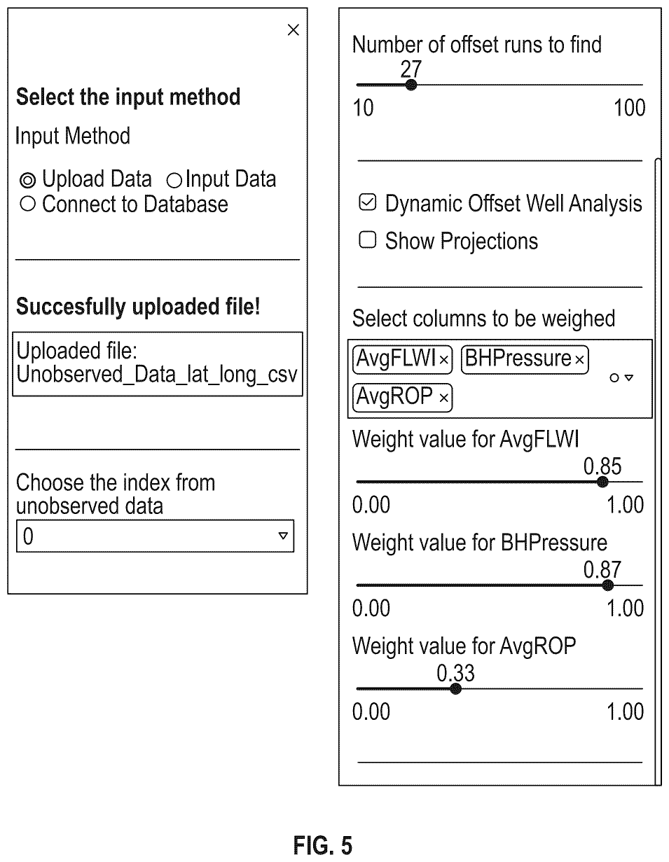

FIG. 5 through FIG. 8 present a specific example of the techniques described above with respect to FIG. 1 through FIG. 4. The following example is for explanatory purposes only and not intended to limit the scope of the one or more embodiments.

Referring now to FIG. 5, a graphical user interface is shown according to illustrative embodiments. The GUI of FIG. 5 is an example of GUI (122), shown in block form in FIG. 1.

The GUI of FIG. 5 includes a section dedicated to parameter selection. For example, a drop-down menu that may list available parameters for selection. Users can click on the drop-down menu to view and/or select parameters for consideration by the comparison algorithm.

Once a parameter is selected from the drop-down menu, a corresponding slider bar appears below the parameter selection section. The slider bar is labeled with the name of the selected parameter and represents the weight assigned to that parameter. The slider bar allows users to adjust the weight visually and interactively according to their preference. The slider bar can include a draggable knob that users can click and drag along the bar to adjust the weight. As the knob is moved, the value of the weight is dynamically displayed and updated in real-time, providing immediate feedback to the user.

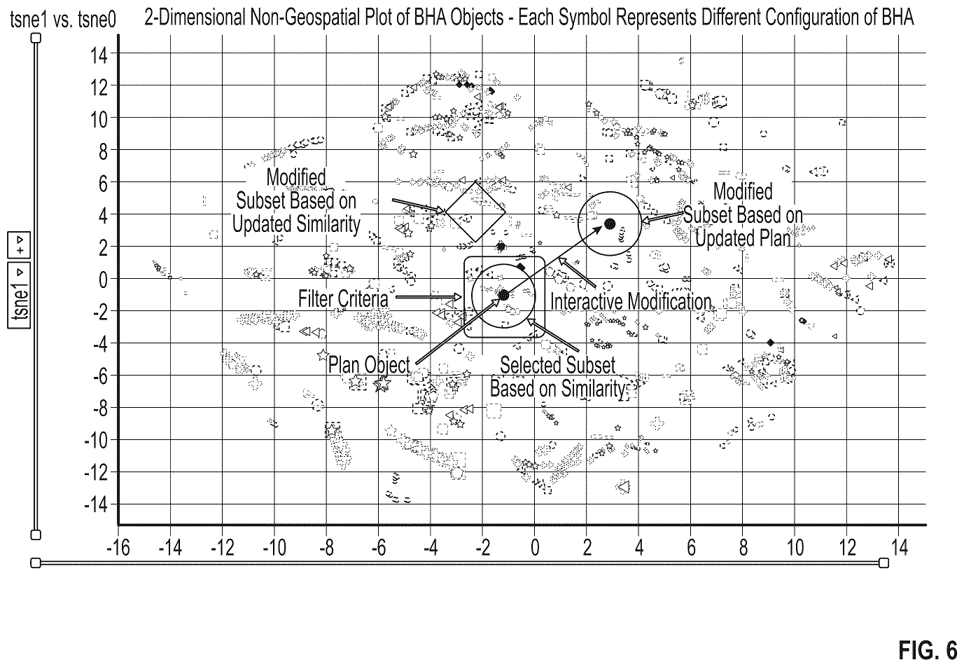

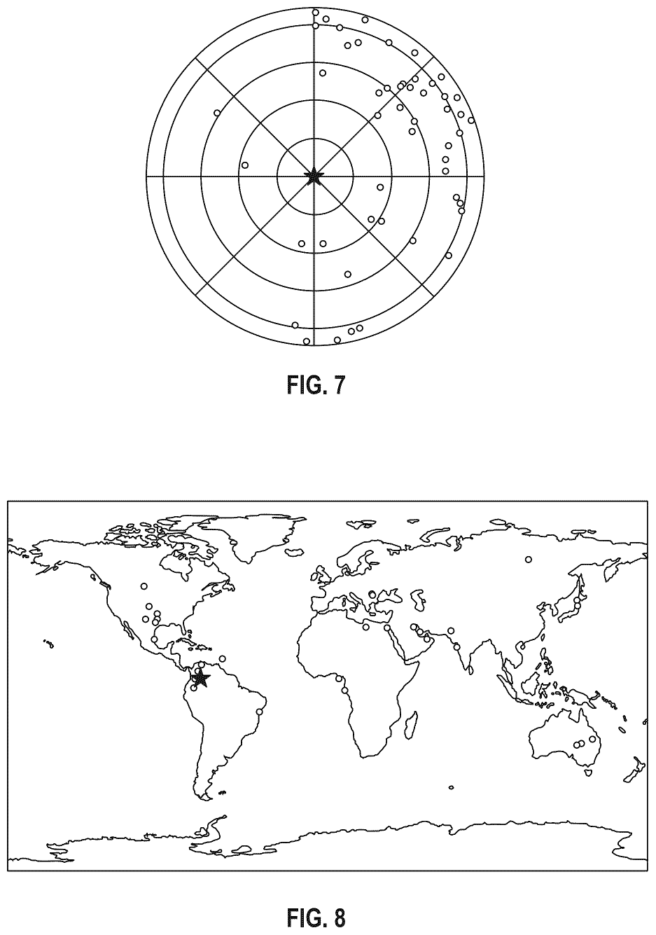

Referring now to FIG. 6, a data visualization is shown according to illustrative embodiments. The visualization of FIG. 6 can be generated by a comparison process, such as comparison process (130) of FIG. 1, and thereafter displayed in a graphical user interface, such as graphical user interface (122) of FIG. 1 and/or graphical user interface (500) of FIG. 5.

In this illustrative example, the visualization is a plot. Specifically, the plot is a two-dimensional plot representing the summary for all the attributes for different wells. The plot in FIG. 6 may be created using a t-SNE (t-Distributed Stochastic Neighbor Embedding) technique, described below. Other techniques may be used to generate the plot. For example, as described below, a uniform manifold approximation and projection for dimension reduction map (UMAP) may be used to generate two-dimensional plots using the methods described herein. In any case, the plot shown in FIG. 6 is displayed within the graphical user interface (GUI), providing a visual representation of the well plans. Each data point in the plot corresponds to a well plan, and its position in the plot reflects its similarity to other well plans.

Initially, when the parameters and weights are set to their default values or initial selections, the plot is generated based on the original set of well plans. The data points are scattered across the plot, with no specific comparison or grouping apparent at first glance. As the user interacts with the GUI and adjusts the parameters and weights, the position of the data points in the plot dynamically changes. The t-SNE algorithm (or possibly another algorithm) may recalculate the positions of the data points based on the updated parameter values and weights.

When the user modifies the selected parameters in the GUI, the plot reflects the impact of these changes. The position of the data points in the plot is rearranged to reflect the new relationships among the well plans based on the modified parameters. Well plans that share similar parameter values will tend to be positioned closer together in the plot, forming clusters or groups.

Similarly, when the user adjusts the weights assigned to different parameters, the plot is updated accordingly. The modified weights influence the importance or significance of each parameter in determining the similarity between well plans. As a result, the position of the data points in the plot is rearranged to reflect the new weighted relationships among the well plans. Parameters with higher weights will have a stronger influence on the positioning of the data points, potentially leading to the formation of new clusters or the merging and/or separation of existing clusters.

By dynamically changing the parameters and weights using the GUI, the user can explore different configurations and observe the effects on the plot. This interactive visualization allows for a better understanding of how different factors contribute to the similarity of well plans based on the selected parameters and weights.

The graphical user interfaces may display other visualizations of objects. For example, Similar objects may be displayed as a radar plot, as shown in FIG. 7, or plotted on a geographical map, as shown in FIG. 8. the addition of radar plots and geographic maps to the graphical user interface (GUI) provides further data insights that may not be readily apparent from the plot alone. Here's how these additional visualization tools can contribute to understanding the well plans:

The radar plot of FIG. 7 displays the values of different variables on multiple axes, with each axis representing a parameter or feature. This visualization allows for a direct comparison of parameter values across multiple well plans. Users can observe the relative importance of each parameter by examining the distance from a centrally plotted plan object. Users can easily identify variations in parameter values and assess the strengths and weaknesses of different well plans in terms of specific parameters. Additionally, the angles visible in the plot are useful (e.g., the increasing rate of penetration (ROP) as the plot is viewed anti-clockwise). The angles may be used to identify similarities more easily. As a result, a user may have an option to focus on a smaller subset of wells while viewing the plot of FIG. 7. In this way, the user may focus on fewer, more relevant offset wells.

The geographic map of FIG. 8 provides a spatial context to the well plans. Each well plan can at its corresponding geographic location. Users can visualize the distribution of well plans across different regions or geological formations.

The geographic map enables users to identify spatial patterns or clusters of well plans. It allows for the recognition of trends or correlations between well plans and their geographical context. Users can observe if certain parameters or clusters of well plans are more prevalent in specific geographic regions, thereby providing insights into the proximity of well plans to exist wells or geological features.

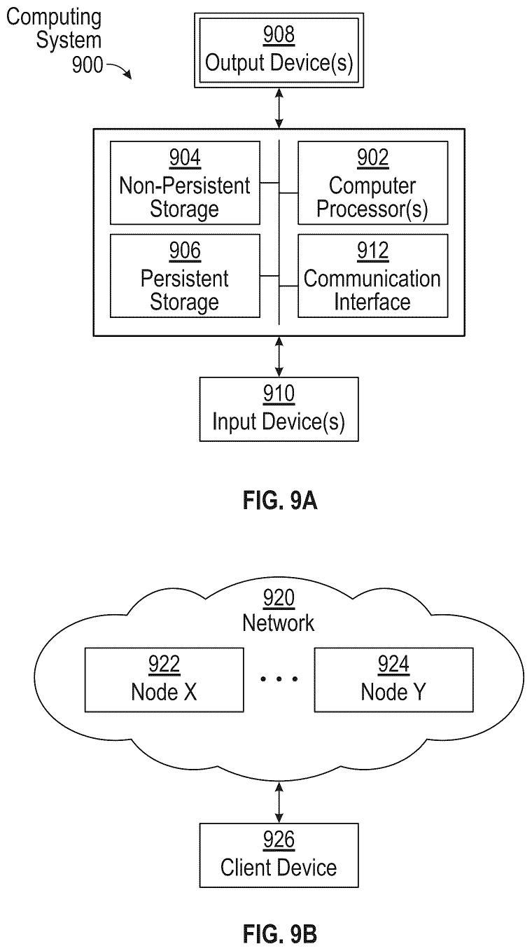

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 9A, the computing system (900) may include one or more computer processors (902), non-persistent storage (904), persistent storage (906), a communication interface (912) (e.g., Bluetooth interface, infrared interface, network interface, optical interface, etc.), and numerous other elements and functionalities that implement the features and elements of the disclosure. The computer processor(s) (902) may be an integrated circuit for processing instructions. The computer processor(s) may be one or more cores or micro-cores of a processor. The computer processor(s) (902) includes one or more processors. The one or more processors may include a central processing unit (CPU), a graphics processing unit (GPU), a tensor processing units (TPU), combinations thereof, etc.

The input devices (910) may include a touchscreen, keyboard, mouse, microphone, touchpad, electronic pen, or any other type of input device. The input devices (910) may receive inputs from a user that are responsive to data and messages presented by the output devices (908). The inputs may include text input, audio input, video input, etc., which may be processed and transmitted by the computing system (900) in accordance with the disclosure. The communication interface (912) may include an integrated circuit for connecting the computing system (900) to a network (not shown) (e.g., a local area network (LAN), a wide area network (WAN) such as the Internet, mobile network, or any other type of network) and/or to another device, such as another computing device.

Further, the output devices (908) may include a display device, a printer, external storage, or any other output device. One or more of the output devices may be the same or different from the input device(s). The input and output device(s) may be locally or remotely connected to the computer processor(s) (902). Many different types of computing systems exist, and the aforementioned input and output device(s) may take other forms. The output devices (908) may display data and messages that are transmitted and received by the computing system (900). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention, which may include transmitting, receiving, presenting, and displaying data and messages described in the other figures of the disclosure.

The computing system (900) in FIG. 9A may be connected to or be a part of a network. For example, as shown in FIG. 9B, the network (920) may include multiple nodes (e.g., node X (922), node Y (924)). Each node may correspond to a computing system, such as the computing system shown in FIG. 9A, or a group of nodes combined may correspond to the computing system shown in FIG. 9A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (900) may be located at a remote location and connected to the other elements over a network.

The nodes (e.g., node X (922), node Y (924)) in the network (920) may be configured to provide services for a client device (926), including receiving requests and transmitting responses to the client device (926). For example, the nodes may be part of a cloud computing system. The client device (926) may be a computing system, such as the computing system shown in FIG. 9A. Further, the client device (926) may include and/or perform all or a portion of one or more embodiments of the invention.

The computing system of FIG. 9A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

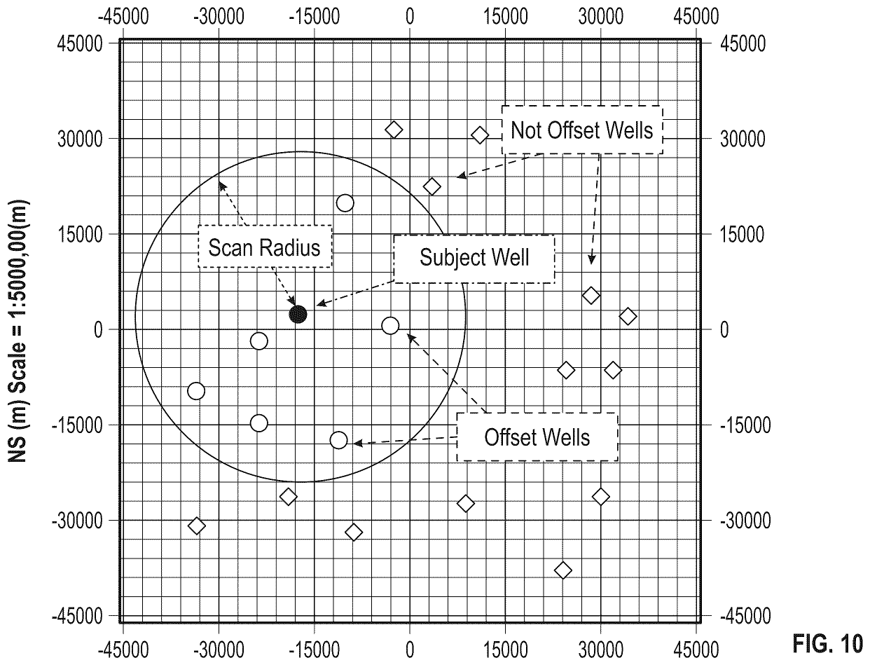

FIG. 10 shows a top view of a group of wells showing offset wells in a radius around a subject well. An offset well is not necessarily a well that is in close proximity to the subject well. There are multiple cases where wells drilled in different parts of the world are similar. For example, wells drilled on the eastern coast of South America have been found to have similarities to those drilled off the coast of West Africa. Additionally, in some cases, offset wells can be considered similar to a target well when the offset wells have similar design attributes independently of whether the offset wells have drilled similar formations.

Another case is that wells can be considered similar when the wells have drilled similar formations with similar results. One or more embodiments provide for using similarity metrics to identify, for a given subject well, one or more offset wells. One or more embodiments take into consideration multiple aspects and provide flexibility by customizing the metrics based on the desires of the user.

The framework of one or more embodiments may provide the capability to select the offset wells and to visualize the offset wells in a GUI to help the end user have an insight into the selection criteria. The application that supports the GUI of one or more embodiments may be used input offset data and criteria and output a set of similar wells (i.e., offset wells using the similarity finding technique using the specified criteria). One or more embodiments then provide for a GUI that presents a visualization of the offset wells using dimension reduction techniques. The GUI may be used to help the users interpret the results correctly.

Referring back to FIG. 6, in one embodiment a high-dimensional comparison analysis between wells may be displayed in the two-dimensional plot of FIG. 6 by reducing the comparison complexity to a distance between wells. Each dot on the plot of FIG. 6 represents a well. The distance between two dots represents the calculated similarity between the two wells. The closer the points are on the plot, the more similar the wells are. If a circle is drawn around the dot that represents the subject well, the wells in that circle will be the wells that are most likely the offset wells. Since the relationship is defined by a unitless coefficient, as the user changes the parameters and the design of the subject well, the point that represents a given well may move to another location on the plot (i.e., the location on the plot that is defined by the newly specific parameters of the well). In this scenario, the offset wells may not move as their parameters may not change, and their relationship to each other, as depicted by the location in the plot, may be fixed. Based on the updated location of the point representing the subject well, and the corresponding circle, the new set of offset wells may be retrieved.

There are different ways to calculate the distances between the different points. If a technique is applied that will allocate a weight for each parameter, for different weights, the distance between different wells would change. The distance (i.e., similarity) changes as the weights are used for determining the importance given to different parameters. Based on the updated distance metric, the points that represent the offset wells would then be located at different positions on the plot.

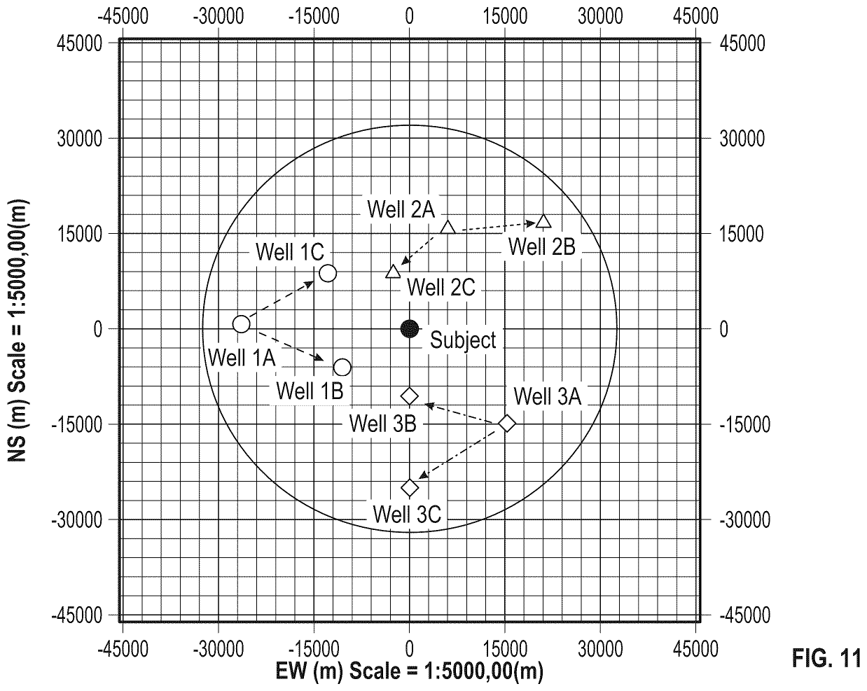

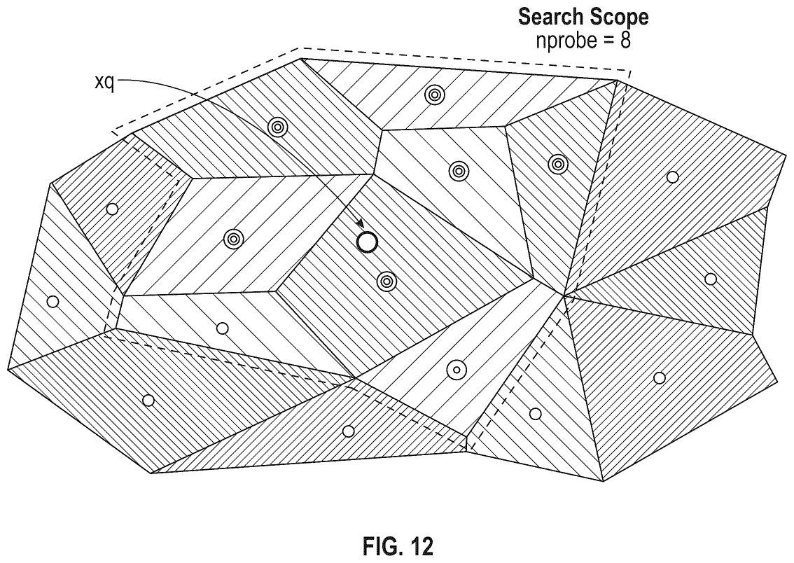

FIG. 11 shows an example of showing well similarity plot in a two-dimensional map, in accordance with one or more embodiments. FIG. 11 may be considered a variation of FIG. 6 in which three wells are considered.

The wells initially are at position A, which is their first position. FIG. 11 illustrates this in on a two-dimensional plot of the top view based on geographical locations. In the example, the wells have only two parameters, rate of penetration (ROP) and total depth, as indicated by the table below:

| | Rate of Penetration | Total Depth |
|---|---|---|
| Well Number | (feet per hour) | (feet) |
| Well 1 | 50 | 10,000 |
| Well 2 | 20 | 11,000 |
| Well 3 | 45 | 16,000 |

The distance between the wells on the plot of FIG. 11 is a derivative of the parameters. If no weighting is applied, the well may appear as denoted by the point at the first location A. However, if a weighting of 90% is applied to the ROP and 10% to the total depth, then wells 1 and 3 move closer together. If the ROP recorded for the subject well is closer to 47.5 feet per hour (ft/hr), then the subject wells also appear close to them. The effect is shown by denoting the location B on the plot.

If the weighting is now reversed and 90% is applied to the total depth of the well and 10% to the rate of penetration, Wells 1 and 2 may move closer together and Well 3 may move away. The effect is denoted by location C.

In this way, a user can define what parameters are of importance in the design and then see an updated representation of the offsets on a single GUI. If the newly retrieved set of offset wells were plotted back on the original two-dimensional plot, the locations of the wells represented by different points would not necessarily be inside the area of the circle drawn earlier. The result occurs because the underlying representation represented by the distance changes based on the weights. The diamond drawn on the plot in FIG. 11 represents the updated set of offset wells, thereby improving the information displayed on the GUI. The weighting scheme allows the framework to be flexible and user-centric, as different users can use the same framework and application to retrieve different offset wells based on the current needs.

In real-world scenarios, there are many more parameters associated with the wells, thus increasing the complexity of the problem, as indicated by FIG. 6. However, using one or more embodiments, users may retrieve offset wells having similar formations and/or similar penetration rates by just updating a few weighting parameters displayed on the GUI. Using the retrieved sets of offset wells, the design comparison could be performed to summarize the differences between wells and define the learned lessons to plan an optimal design for future wells.

Thus, one or more embodiments provide for a dynamic, data-driven offset well analysis. The dynamicity in the process of offset well analysis is introduced by the weighting scheme. The framework includes a data-driven techniques that allow the combination of the user-defined weights and the collected data to retrieve and display the right set of offset wells in a manner that a human user may easily understand. The data drive techniques may include nearest neighbor clustering techniques (e.g., a k-nearest neighbor clustering technique). The clustering shown in FIG. 11 may be generated using a nearest neighbor clustering technique. However, other clustering techniques may be used.

For example, FIG. 12 shows an inverted file index clustering technique portrayed using a Voronoi diagram, in accordance with one or more embodiments. One or more embodiments may reduce the search space across which the embeddings are compared. The technique may be implemented using an inverted file index (IVF). IVF creates a hash map-based, reduced representation of available data points. Clustering of the points happens using a Voronoi diagrams, such as shown in FIG. 12.

Initially, a few points are sampled from the data space, which serve as the centroids of the clusters. From the few points, circles of equal radius are extended to form the clusters. For the incoming query point, first, the cluster to which a point belongs is determined. Then, based on the proximity of other clusters to that particular cluster, the search scope, determined by the hyperparameters given to the algorithm, is defined. In this manner, the search space is reduced from the entire data space to a few selected clusters, thereby speeding up the determination and also presenting the resulting clusters on a user-friendly GUI.

FIG. 12 also represents the selection process for the method. The clusters with hash lines represent the space that would not be explored while retrieving the closest points for the query object represented as “xq” in FIG. 12.

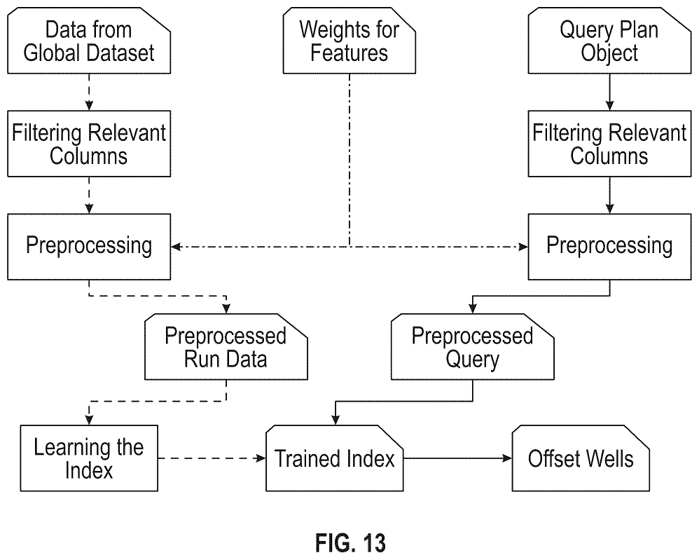

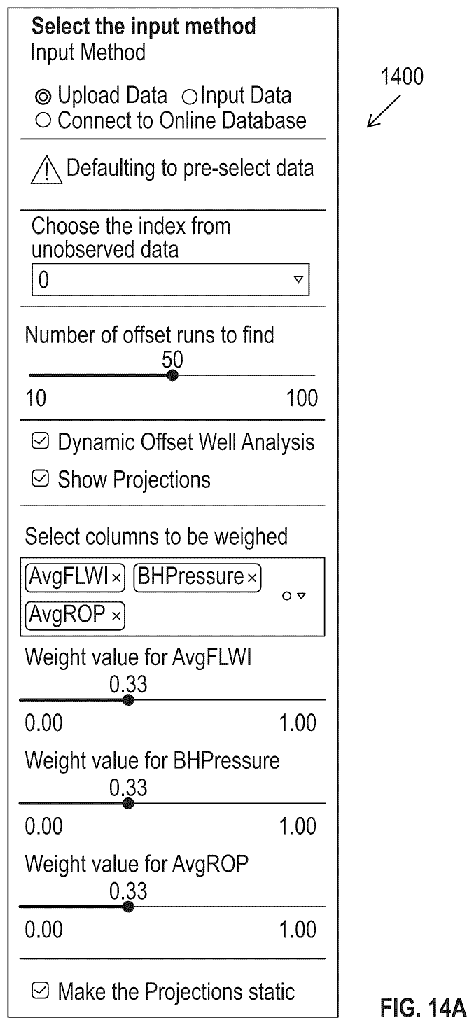

FIG. 13 is a flowchart representing a workflow for dynamic data-driven offset well analysis, in accordance with one or more embodiments. The workflow of FIG. 13 is divided into three main phases: a training phase, an inference phase, and a updated offset well generation phase.

The training phase involves using the collected run-level data from the online database (or global database), filtering relevant columns, and further preprocessing the data. Once the data have been preprocessed, the data are used to generate an index representing the calculated similarity between different data points.

In the inference phase, when the query plan from the user is received, the query plan is passed through the same preprocessing steps. The offset wells are retrieved using the trained index.

In the updated offset well generation phase, the component that allows the system to be dynamic is the weights. Once the user enters the weights signifying the importance to be given to different drilling parameters, they are passed to the preprocessing functions, and the updated preprocessed data are generated. The preprocessed data are then further passed through all the following steps to give an updated set of offset wells. In this stage, the preprocessing functions consider the weights defined by the user and use those while generating the preprocessed data.

An element in all of the nearest neighbor retrieval techniques is the distance function. Different types of distance functions, for example, cosine similarity, Euclidean distance, and Manhattan distance, are supported by these methods. One or more embodiments may use the Euclidean distance because the application of weights is more intuitive in Euclidean distance than in other distance functions. Equation I represents the function for calculating Euclidean distance between two n-dimensional data points.

$${d}_{i j} = \sqrt{{( {x}_{i} - {x}_{j} )}^{2} + {( {y}_{i} - {y}_{j} )}^{2}} \qquad ( I )$$

As can be seen from equation I, each parameter plays an equal role in determining the eventual numeric representation. However, since the scales of different drilling parameters are varied, the numeric representation could be overwhelmed by a huge number from one of the parameters, and the effects of the other parameters might be underrepresented. However, a preprocessing step may performed, passing the data points through a minimum-maximum scaling function. Equation II represents the function for minimum/maximum scaling:

$${x}_{scaled} = \frac{( {x}_{original} - min ( {x}_{original} ) )}{( max ( {x}_{original} ) - min ( {x}_{original} ) )} \qquad ( II )$$

The minimum-maximum scaler scales the data such that the minimum value corresponds to 0 and the maximum value corresponds to 1. Unlike standard scaling, which makes the data close to a normal distribution with a mean of 0 and standard deviation of 1, the minimum-maximum scaler helps maintain the data distribution as it does not reduce the effect of outliers, but the minimum-maximum scalar linearly scales the effect of outliers down into a fixed range. In the fixed range, the largest occurring data-point corresponds to the maximum value and the smallest one corresponds to the minimum value. This effect is useful, as the distance metric depends on the data distribution. Further, the experiments supported the intuition of using the minimum-maximum scaler, as the framework's performance degraded with the use of the standard scaling function.

Equation III represents the weights incorporated into the Euclidean distance. As the weights are separately applied to different features, it is possible to control the selected weights to the weights representing the importance of different parameters. Since the parameters would already be scaled, the importance defined by the weights plays an equal role across different parameters and would be agnostic to the scale of parameters.

$${d}_{i j} = \sqrt{{{w}_{x} ( {x}_{i} - {x}_{j} )}^{2} + {{w}_{y} ( {y}_{i} - {y}_{j} )}^{2}} \qquad ( III )$$

After consideration of how weights become part of Euclidean distance, to optimize the run-time and balance the modifications used by the underlying nearest-neighbor retrieval technique, the weights were factored out of the distance function and associated directly with the preprocessing step. The approach further supports the framework's modularity, where a nearest-neighbor retrieval technique could be incorporated into the overall workflow. Thus, the preprocessing pipeline becomes a two-stage process where the first stage involves scaling the parameters, and the second stage involves applying the scaled factor representing the weights defined by the users.

The scaled factor is calculated based on the normalized weights for each parameter. The normalized weights remove the user's burden to define the exact weights for different parameters. Instead, the user can define weights in percentage terms for each parameter that requires scaling, and then the user specified weights are internally normalized by the application.

For the technique to train the index to retrieve the nearest neighbors, two of the techniques, namely naive K-nearest neighbor and inverted file index described above, have been used. The simplicity of the two techniques allows the techniques to be extensible to make the results more easily interpretable by the users. Since the framework considers the weight updates in the preprocessing steps, the underlying technique to retrieve the nearest neighbors could be replaced with other techniques.

One or more embodiments contemplate using different distance metrics. While one or more embodiments described above refer to determining Euclidean distances, other techniques such as cosine similarity also may be used as a distance metric for similarity. Thus, the examples described above do not necessarily limit the use of other similarity metrics or other similarity determination techniques.

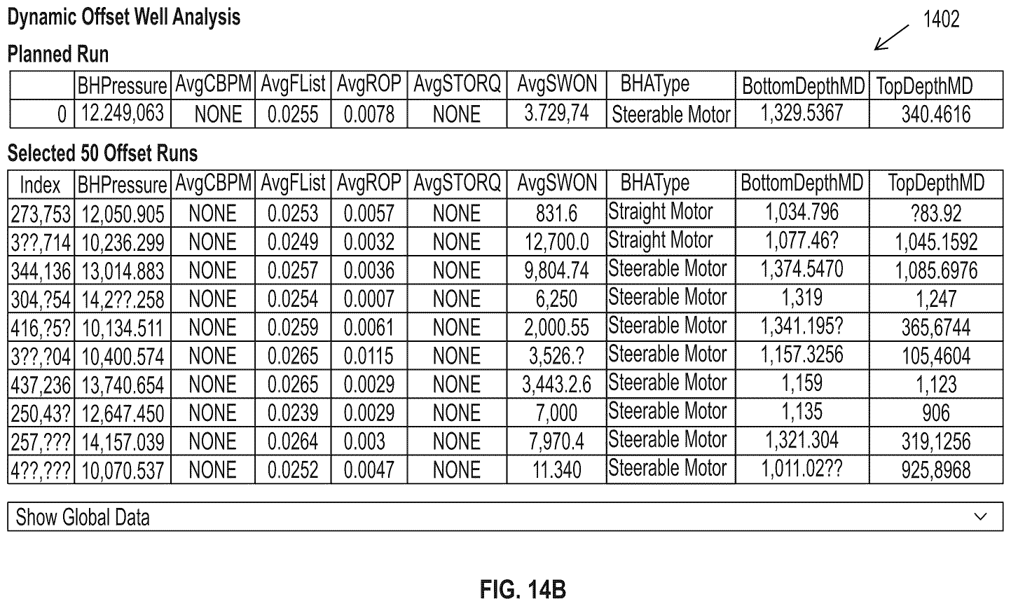

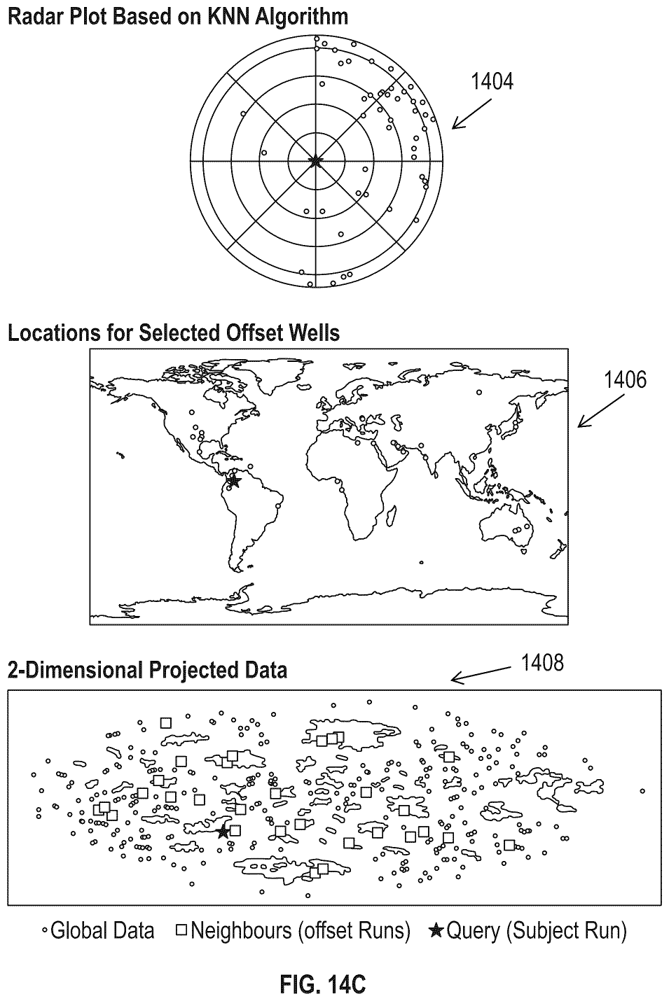

FIGS. 14A-C show alternative graphical user interfaces for displaying and manipulating offset well data, in accordance with one or more embodiments. The following section describes a software application to make the framework accessible to the end users.

In some embodiments, displaying and manipulating offset well data can be in a single graphical user interface. For example, the graphical user interfaces 1400, 1402, 1404, 1406, and 1408 illustrated in FIGS. 14A-C can be a single user interface. In other embodiments, displaying and manipulating offset well data can be in more than one graphical user interface. For example, graphical user interfaces 1400, 1402, 1404, 1406, and 1408 illustrated in FIGS. 14A-C can each respectively be standalone graphical user interfaces.

There are three main components to the application interface of the software application shown in FIGS. 14A-C: (1) ways to input the details of the planned subject well, (2) interface to allow interactive modifications and define importance weights for different well parameters, and (3) the interface to allow users interpret the results from the framework. For the application development and front-end creation an open-source library, may be used. The framework and the application were implemented in Python. The source-code, including the front-end and the framework for offset well retrieval, may be then containerized in a Docker container, and deployed on the Kubernetes-based cloud environment.

FIG. 14A depicts the interface 1400 of the software application. As shown in FIG. 14A, the application provides three different methods for users to input the information for the subject well. The three methods include entering the subject well information in the form of a comma separated value (CSV) file summarizing the different parameters, entering the information in a set of input boxes, and a connecting to an online database hosting the global dataset for the wells.

The first method allows the users to represent the information of the subject that the user may have exported from other software supporting the planning for the subject well. The method further could be useful for integrating the workflow into any of the downstream applications, as the method allows the framework to be accessed through the data. Such framework access could allow the framework to be considered as a node in a graph representing the different processing steps with the data flowing in and out of the node through different edges. The application also allows users to retrieve the data for the set of offset wells into a CSV file.

The interface 1400 also allows users to interact with the data of the subject well and to define the importance weights. The slider bars, as shown in the left panel of FIG. 14A may be used to achieve the user functionality. The users can use these bars to define the desired number of offset wells as well as the weights for different parameters, signifying the importance of that parameter in the distance function. The users can use the drop-down menu to search and select the parameters for which the users want to define the weights.

The GUI also provides an interface to display the results to the users such that the users can get the most out of the application. Four different forms of representation are provided for the users to understand and interpret the results, as illustrated in FIGS. 14B and 14C.

First, a tabular representation 1402 of the raw data from the global dataset for the retrieved set of offset wells may be displayed, as illustrated in FIG. 14B. Generating the display of the tabular representation 1402 may be an interactive block that allows the users to sort, filter, search, and export the results from the application.

The second representation is a radar plot 1404, as shown FIG. 14C as “Radar Plot based on KNN Algorithm”. The radar plot 1404 has a center, which is the bull's eye representing the subject well. The radius represents the similarity of the different points with the subject well. As the radius increases (i.e., the farther one goes from the center), the similarity of the wells with the subject well is reduced. The angle or the phase in the radar plot could be useful to signify the growth of any of the parameters. The user may specify the angle or phase in the radar plot before initiating the application.

For example, the users could specify the angle to represent the average rate of penetration (ROP). In this case, the angle θ represents the wells with minimum average ROP, and as one moves in a counterclockwise direction, the average ROP of the wells would increase. The division of the circular region into eight parts further allows the users to bin the wells into different classes, thus providing a relative understanding of the underlying distribution.

The third representation is a geographic plot 1406 showing the locations of different wells on the world map based on the location information for these wells as shown in FIG. 14C as “Locations for Selected Offset Wells”. The plot 1406 allows the users to understand the physical locations of the wells and, if further desired, narrow down the analysis by filtering out the wells based on some location criteria. Significantly, as can be seen from the plot in FIG. 14C, the offset wells retrieved by the developed framework are not necessarily restricted to the geographical proximity of the subject well. Enlarging the number of offset wells to include geographically distinct wells supports global knowledge sharing by allowing global datasets to be used in a more efficient way.

A fourth component for the visualizations is a two-dimensional plot 1408 representing the wells as shown in FIG. 14C as “2-Dimensional Projected Data”. The two-dimensional plot 1408 permits the users a view into the core algorithm of the framework. The two-dimensional plot 1408 represents all the wells from the dataset in a two-dimensional form, and highlights the location of the subject well and the corresponding offset wells. The plot allows the users to understand the distribution of the underlying data and further to understand the impact of the weights defined by them.

In the example two-dimensional plot 1408 shown in FIG. 14C, the offset wells are not in close proximity to the subject well because of the defined weights. Returning to the example, the representation aligns with the existence of the diamond in FIG. 6.

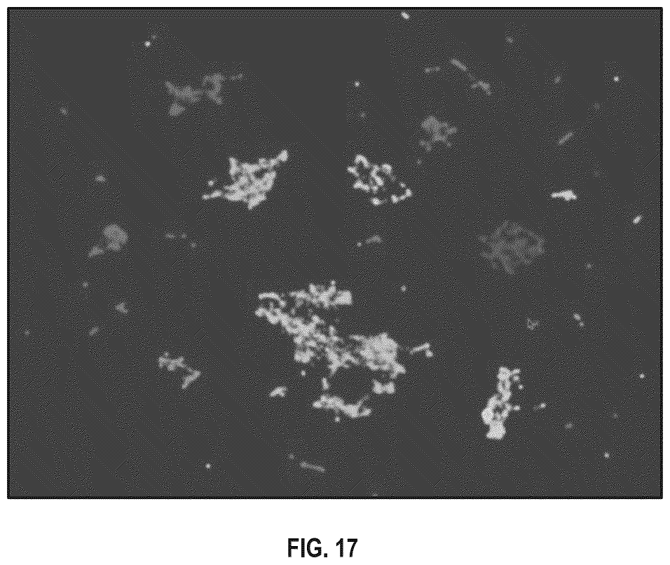

For reducing the representation of all the wells into two dimensions, different dimensionality reduction techniques could be used. For example, a uniform manifold approximation and projection for dimension reduction map (UMAP) may be used to represent the wells into two dimensions (see, for example, FIG. 17). The UMAP technique reduces dimensionality of the underlying data while concurrently permitting a user-intuitive presentation of the data, as shown. UMAP is a dimension reduction technique that can be used for visualization similarly to t-SNE but also for general nonlinear dimension reduction. UMAP may construct a high-dimensional graphical representation of the data and then optimize a low-dimensional graph to be as structurally similar as possible. UMAP offers a number of advantages over t-SNE, most notably increased speed and better preservation of the data's global structure. Based on the considerations of efficiency and real-time aspects of running the dimensionality reduction, users are given an option to enable/disable the rendering of this particular plot.

The previously described forms of visualization assist the users in understanding, analyzing, and defining the right settings for the specific offset wells that they want to retrieve. The visualizations are constant for both of the techniques discussed in the section describing the methodology.

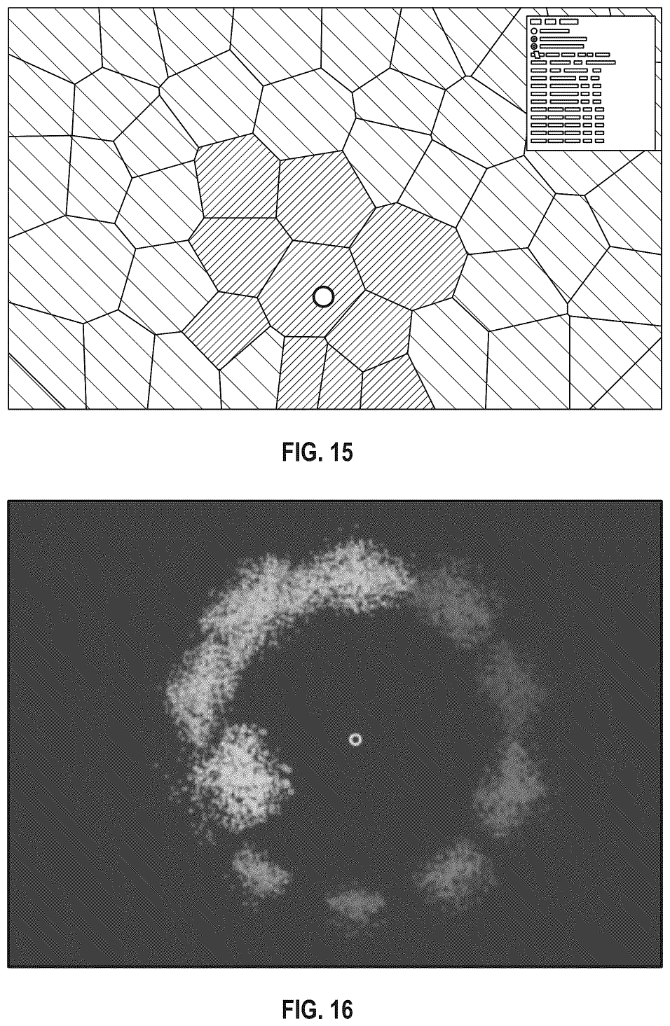

Attention is now turned to FIG. 15, FIG. 16, and FIG. 17, which should be considered as a whole. FIG. 15 is a user interface depicting the interface of interacting with the clusters extracted according to the inverted file index technique, in accordance with one or more embodiments. The GUI of FIG. 15 allows users to interpret the formulated clusters and the distribution of the data within the clusters to better analyze the data and the retrieved offset wells. FIG. 16 is a user interface depicting the interface of interacting with the points inside highlighted clusters in the form of a radar plot, in accordance with one or more embodiments. Points of the same shading in FIG. 16 belong to the same cluster. FIG. 17 is a user interface depicting the interface of interacting with the points inside the highlighted clusters in the form of a two-dimensional plot, in accordance with one or more embodiments, in accordance with one or more embodiments. Points of the same color in FIG. 17 also belong to the same cluster.

For the second technique (inverted file index (IVF)), which involves approximation by clustering the points before the distance computation, a different visualization was created to allow users to interpret the approximation under the hood for that particular method. As shown in FIG. 15, the users can visualize the clusters extracted. The users can also interact with different clusters to see a summarized representation for that cluster. As a result, the users may interpret why those wells were included in the same cluster.

The highlighted clusters in FIG. 15 are the closest clusters to the cluster containing the subject well, which is represented by the white circle. The highlighted clusters represent the reduced search space and are the ones from which the subject wells are retrieved. Further, the users can also visualize the distribution of the points in the highlighted clusters in the form of a radar plot where all the points are shown in a shading based on the clusters to which they belong, as shown in FIG. 16. Similarly, a similar shading technique could be applied on the two-dimensional plot created using UMAP, as shown in FIG. 17. In both FIG. 16 and FIG. 17, a circle represents the subject well.

While one or more embodiments have been described with respect to different clustering techniques (e.g., k-nearest neighbor (KNN) or IVF), other clustering or similarity finding techniques could be used. Thus, the examples provided herein do not necessarily limit other possible techniques for generating clusters of offset wells.

Thus, one or more embodiments provide for approximation techniques which allow speeding up the search process at a very minute cost for little or no loss in accuracy, and then presenting the resulting information on a user-friendly GUI. The one or more embodiments also provide for a workflow for dynamic data-driven offset well analysis. One or more embodiments may provide for broader scale applicability by allowing the users to define the importance of different parameters.

One or more embodiments may be used for multiple purposes by varying the defined importance. The GUI interfaces described herein may provide users insights into the selection criteria, making the framework much more interpretable. One or more embodiments provide for extracting similarity on a wide range of data types to deliver answers to complex questions that may be ask when planning wells. The framework of one or more embodiments is also useful for making complex queries.

As an example, an engineer could ask the application, “Which wells globally had similar trajectories?” or “Which wells globally had similar parameters?” or even “Which wells globally had similar formations?”. One or more embodiments may provide the answers to the questions, and then the answers may be used in the planning process for the next well. Thus, the developed framework of one or more embodiments could be used to enhance the efficiency of drilling engineers by providing a data-driven centralized digital solution.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the term “or” is an “inclusive or” and, as such includes the term “and.” Further, items joined by the term “or” may include any combination of the items with any number of each item unless, expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving a parameter selection of a set of parameters on a well plan comparison tool displayed in a graphical user interface (GUI) to obtain a selected set of parameters;
for each parameter in the selected set of parameters, receiving a weights selection of a set of weights from the well plan comparison tool;
weighting parameter values for a plurality of objects according to the set of weights to obtain weighted parameter values;
analyzing the plurality of objects according to the weighted parameter values to form a plurality of clusters; and
displaying the plurality of clusters on the well plan comparison tool in the GUI.

2. The method of claim 1, wherein the plurality of clusters represents a plurality of clusters of wellbores and wherein the parameter values comprises exploration and production (E & P) data of drill plans for a plurality of wellbores.

3. The method of claim 1, wherein analyzing further comprises:
grouping the plurality of objects into heterogeneous clusters based on only corresponding weighted parameter values for the selected set of parameters that were selected.

4. The method of claim 1, wherein displaying the plurality of clusters further comprises:
displaying the plurality of clusters on the well plan comparison tool as a two-dimensional plot.

5. The method of claim 4, wherein the two-dimensional plot comprises one of a t-SNE (t-Distributed Stochastic Neighbor Embedding) plot, a Voronoi diagram, and a uniform manifold approximation and projection for dimension reduction (UMAP) plot.

6. The method of claim 1, wherein displaying the plurality of clusters further comprises:
displaying the plurality of clusters on the well plan comparison tool as a radar plot.

7. The method of claim 1, wherein displaying the plurality of clusters further comprises:
displaying the plurality of clusters on the well plan comparison tool in a geographic map.

8. A system comprising:
a processor;
a data repository in communication with the processor and storing objects having plurality of parameter values;
a comparison process executable by the processor to:
receive a parameter selection of a set of parameters on a well plan comparison tool displayed in a graphical user interface (GUI);
for each parameter that is selected, receive a weights selection of a set of weights from the well plan comparison tool;
weight parameter values for a plurality of objects according to the set of weights;
cluster the plurality of objects according to the weighted parameter values to form a plurality of clusters; and
display the plurality of clusters on the well plan comparison tool in the GUI.

9. The system of claim 8, wherein the plurality of clusters represent a plurality of clusters of wellbores and wherein the parameter values comprise exploration and production (E & P) data of drill plans for a plurality of wellbores.

10. The system of claim 8, wherein analyzing further comprises:
grouping the plurality of objects into heterogeneous clusters based on only corresponding weighted parameter values for the set of parameters that were selected.

11. The system of claim 8, wherein displaying the plurality of clusters further comprises:
displaying the plurality of clusters on the well plan comparison tool as a t-SNE (t-Distributed Stochastic Neighbor Embedding) plot.

12. The system of claim 8, wherein displaying the plurality of clusters further comprises:
displaying the plurality of clusters on the well plan comparison tool as a radar plot.

13. The system of claim 8, wherein displaying the plurality of clusters further comprises:
displaying the plurality of clusters on the well plan comparison tool in a geographic map.

14. A non-transitory computer readable medium comprising computer readable program code for a graphical user interface (GUI) of a computing system, the graphical user interface comprising:
a display of visualizations on a well plan comparison tool displayed on the GUI, wherein the visualizations is formed by a processor executing a computer-implemented method comprising:
receiving a parameter selection of a selected set of parameters on the well plan comparison tool displayed in the GUI;
for each parameter that is selected, receiving a weights selection of a set of weights from the well plan comparison tool;
weighting parameter values for a plurality of objects according to the set of weights;
analyzing the plurality of objects according to the weighted parameter values to form a plurality of clusters; and
displaying the plurality of clusters on the well plan comparison tool in the GUI.

15. The non-transitory computer readable medium of claim 14, wherein the plurality of clusters represent a plurality of clusters of wellbores and wherein parameter values comprises exploration and production (E & P) data of drill plans for a plurality of wellbores.

16. The non-transitory computer readable medium of claim 14, wherein analyzing further comprises:
grouping the plurality of objects into heterogeneous clusters based on only corresponding weighted parameter values for the selected set of parameters that were selected.

17. The non-transitory computer readable medium of claim 14, wherein displaying the plurality of clusters further comprises:
displaying the plurality of clusters on the well plan comparison tool as a t-SNE (t-Distributed Stochastic Neighbor Embedding) plot.

18. The non-transitory computer readable medium of claim 14, wherein displaying the plurality of clusters further comprises:
displaying the plurality of clusters on the well plan comparison tool as a radar plot.

19. The non-transitory computer readable medium of claim 14, wherein displaying the plurality of clusters further comprises:
displaying the plurality of clusters on the well plan comparison tool in a geographic map.
